(19) United States
(12) Patent Application Publication
(10) Pub. No.: US 2003/0063911 A1
(43) Pub. Date: Apr. 3, 2003

(54) Developing tray for diazo

(76) Inventor: George Marshall Sawyer, Orem, UT (US)

Correspondence Address: GEORGE M. SAWYER, 1360 W 130 S, OREM, UT, 84058, US

(21) Appl. No.: 10/256,486

(22) Filed: Sep. 26, 2002

Related U.S. Application Data
(60) Provisional application No. 60/325,957, filed on Oct. 1, 2001.

(51) Int. Cl. G03D 13/04

(52) U.S. Cl. 396/636

(57) ABSTRACT

This invention facilitates the development of Diazo papers in small applications where a hand held unit is desirable. An example is where children want to make a silhouette print of a leaf. It accomplishes the following:

1. It produces a hand held device that

2. exposes in sunlight for less than 1 minute, and

3. processes dry in less than one minute, and

4. produces a dry print, and

5. produces a print that is a positive (the print is to be dark where a leaf is located between the light source and the Diazo sheet.).

### CROSS REFERENCE TO RELATED APPLICATIONS

This application claims priority from:

Provisional Application: No. 60/325,957

Filing Date: Oct. 1, 2001

Title: DEVELOPING TRAY FOR DIAZO

### BACKGROUND OF THE INVENTION

Photographic prints of leaves, pressed flowers, and other objects can be made by (1) obtaining a sheet of light sensitive material (“sheet”), and (2) placing the object between a light source and the sheet, and (3) exposing, and developing (or processing); a print results. The equipment used is small, and hand held.

Prior Art Commonly Teaches the Use of Sheets Known as SUNPRINT™ Papers.

These may be obtained from Unique Crafters Company, 10702 Trenton Ave., St. Louis, Mo. 63132. Using these prior art sheets, There are disadvantages in using these prior art sheets; the reasons are these; It takes minutes to expose in direct sunlight, it takes minutes to process (it is processed by immersing in water), and it takes minutes to dry, and the image formed is a negative (meaning that on the print where the leaf was it is light, and where the leaf was not (the part exposed to light) it is dark.

The Inventor of the Instant Invention Looked for a Way to Make a Better Product.

The objective of his search addressed the following 5 goals:

1, produce hand held equipment that

2, exposes in sunlight for less than 1 minute, and

3, processes dry in less than one minute, and

4, produces a dry print, and

5, produces a print that is a positive (the print is to be dark where the leaf was).

It was known to the inventor that blueprints can be made by the Diazo Process and that Diazo prints are made by exposing to light and than processing with ammonia gas (that is essentially dry). This inventor obtained some Diazo papers that were capable of producing either a positive or a negative image. The only means known, to the inventor, of processing the exposed Diazo was by the use of very big floor mounted machines.

Because the inventor was concerned about the ammonia gas being a disadvantage because of the smell and possible toxicity, he sought ways to provide enough ammonia to develop the exposed sheet, and no more. It was realized that in order to develop the sheet, only a very thin layer of ammonia gas to cover the sheet would be needed.

Furthering this thought, the inventor thought that it would be nice if a developing sheet could be used to overlay the exposed Diazo sheet; this developing sheet would produce ammonia gas on command. It was thought that a developing sheet that produced ammonia gas when heated, as with a clothes iron set on “cotton” would be just what was wanted. So the idea is to impregnate a cloth or paper with a chemical with some material that would emit ammonia gas when heated with an iron.

Many chemicals that decomposed when heated and produced ammonia gas were tried. When small samples of paper were impregnated with various chemicals, it was found that many emitted ammonia gas just sitting there at room temperature. So the search focused on chemicals that were very stable at room temperature but that readily emitted ammonia gas when heated with a clothes iron. One chemical was especially ideal with properties of being stable at room temperature but that readily emitted ammonia gas when heated with a clothes iron. A sheet impregnated with this chemical is termed a “developing paper.” This was the way it worked: After exposing a sheet of light sensitive paper to the sun with a leaf on top of the sheet, the sheet was placed on a flat surface, overlain with the developing paper, and ironed with a clothes iron set at “cotton.” This worked very well. This product was really going to set the world on fire. Thousands of square feet of developing papers were impregnated, dried, and cut into 4×5 inch sheets convenient for using in hand held devices.

On second thought, the process did have disadvantages. For one thing, the developing papers did deteriorate somewhat over a long period of time, and for a second thing, the use of a very hot clothes iron by children (where a substantial part of the market exists) were disadvantages.

The question was then raised, “Is there some way to produce ammonia gas in small amounts in a small confined space and where the exposed Diazo sheets could be put into this small confined space and thus be developed?”

Clear ammonia in bottles is readily available in grocery stores, and has had a long history of usage in the home. Thus, Clear Ammonia is already a consumer item with warnings and cautions on the label. Clear Ammonia is ammonia gas dissolved in water, and ammonia gas comes out of the water and fills the space above the surface of the clear ammonia and below the cap.

A closed container, in the form of a wide mouthed bottle with wide mouthed lid, was designed. The wide mouthed lid was slotted, and a piece of transparent tape, with folded over ends to make it easy to remove, was placed over the slot. A piece of ordinary household cellulose sponge was placed in the bottom of the bottle. To charge it up, the lid was removed, and Clear Ammonia was poured into the bottle and over the sponge until the sponge was saturated, and the lid with covered slot was put in place. To use this an exposed sheet of Diazo paper is obtained, the tape covering the slot is removed, and the sheet is inserted into the slot and thus into the ammonia gas that is in the top part of the container. When the sidewalls of the container are of transparent material, one can watch the development process take place as the sheet changes to dark purple or blue (when this type of Diazo is used). The part of the sheet that was being held by the fingers, and not at first developed, is then processed by removing the sheet form the slot, turning the sheet end-for-end and inserting the end that was not initially exposed into the slot. FIG. 1 illustrates these features. The container 11, preferably made with transparent sidewalls, the lid 12 with slot 13. A sponge 14 saturated with clear ammonia, a small puddle of clear ammonia 15, ammonia gas 16 (the random dots in the drawing), and an exposed Diazo sheet 17, located partially in within the container, are shown. Diazo sheets can be made as sepias, black, blue, and negative and positive.

A principal disadvantage of the design above described and illustrated by FIG. 1 is that it is bulky.

The inventor seeks a less bulky design that is just a little larger than the exposed sheet in plan view and thin in the side view. This is the subject of the invention that is described in the following descriptions and claims.

### BRIEF SUMMARY OF THE INVENTION

The invention, “A developing Tray for Diazo”, is a less bulky design than the prior art and the plan view shows that the dimensions need not be much larger than the size of the exposed Diazo sheet; the thickness can be less than one inch.

### BRIEF DESCRIPTION OF THE DRAWINGS

FIG. 1 is a cross section of a developing jar.

FIG. 2 is a plan view of a developing tray.

FIG. 3 is a side view of the developing tray, in cross section AA′ shown in FIG. 2

FIG. 4 is an end view of a developing tray.

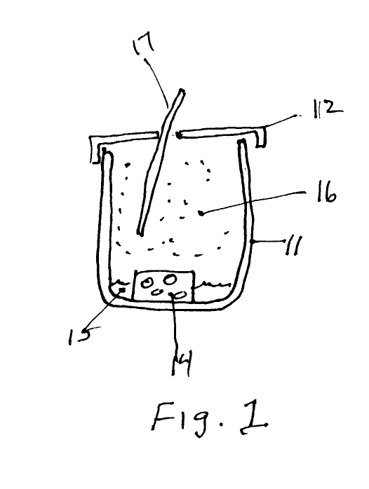

### DETAILED DESCRIPTION

The invention is a less bulky design than the prior art and may be just a little larger than the exposed sheet in plan view and thinner in the side views and is hand held..

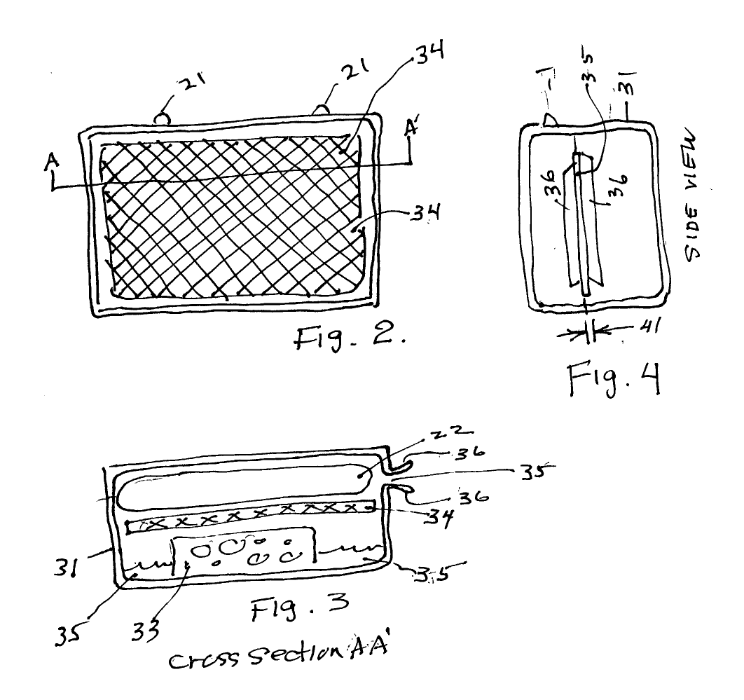

FIGS. 2, 3, and 4 show a container 31 with a transparent top 32, an optional hinge 21, an absorbent material 33 that may be of cellulose or innumerable other materials, a spacer sheet 34, that is preferably of plastic, the spacer sheet 34 as openings, as a screen, or with holes, or with slots, the developing space, absorbent material 33 is preferably saturated with clear ammonia and clear ammonia may form puddles 35. A method of using this one version of this device with a lid tht opens and closes, is to open the lid and insert the exposed Diazo sheet, close the lid, watch the development process, and open the lid and remove the developed Diazo sheet. When used that way, the lid closely fits the top of the container, all the way around in order to reduce the escapement of ammonia gas.

However, another way to use this device is to make a thin opening 35 into which the exposed Diazo sheet can be inserted.. Also, to facilitate the ease of placing the exposed sheet into the thin opening 35 which may have a length that is at least 10 times its thickness 41, is by using one or two lips or platforms 36 are located in close proximity of the thin opening.

I claim:

1. A method of developing Diazo sheets that have been exposed to light by the following method:
1. obtain a hand held device with a lid that opens and closes that comprises
an absorbent material,
wherein absorbent material comprises clear ammonia, and a developing space into which an exposed Diazo sheet can be placed, and wherein a spacer sheet is located between the developing space and the absorbent material, and
2 open the lid, and
3 put the exposed Diazo sheet into the developing space, and
4 close the lid, and after more than one tenth of a second,
5 open the lid, and
6 remove the Diazo sheet.

2. A method of developing an exposed Diazo sheet by the following method:
1 obtain a hand held device with a thin opening where the length of the opening is at least 10 times the thickness, and that comprises
an absorbent material,
wherein absorbent material comprises clear ammonia, and a developing space into which an exposed Diazo sheet can be placed, and wherein a spacer sheet is located between the developing space and the absorbent material comprising clear ammonia, and
2 place part of the exposed Diazo sheet into the thin opening, and
3 push the sheet in so at least part of the sheet is within the developing space, and after more than one tenth of a second,
4 pull the Diazo sheet out of the developing space.

3. A method of developing an exposed Diazo sheet by the following method:
1 obtain a hand held device with a thin opening where the length of the opening is at least 10 times the thickness, and where one or more lips are located in close proximity to the thin opening, and that comprises
an absorbent material,
wherein absorbent material comprises clear ammonia, and a developing space into which an exposed Diazo sheet can be placed, and wherein a spacer sheet is located between the developing space and the absorbent material comprising clear ammonia, and
2 place part of the exposed Diazo sheet into the thin opening, and
3 push the sheet in so at least part of the sheet is within the developing space, and after more than one tenth of a second,
4 pull the Diazo sheet out of the developing space.
